(19) United States
(12) Patent Application Publication
(10) Pub. No.: US 2006/0166729 A1
(43) Pub. Date: Jul. 27, 2006

(54) Lottery and gaming systems with electronic instant win games

(75) Inventors: Ali Saffari, Reno, NV (US); Bryan Wolf, Reno, NV (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: IGT, Reno, NV (US)

(21) Appl. No.: 11/044,417

(22) Filed: Jan. 27, 2005

(51) Int. Cl. G06F 19/00; G06F 17/00

(52) U.S. Cl. 463/17

(57) ABSTRACT

The invention is directed to a gaming network and method for conducting an electronic wagering game, such as an instant win game, at the gaming network. The electronic wagering game may include selecting at least one outcome record from a finite pool of outcome records for the wagering game stored in the gaming network, storing the selected outcome records on a portable storage device, and distributing the portable storage device to a player. The electronic wagering game may further include receiving the portable storage device from the player at a redemption device of the gaming network, reading at least one outcome record from the portable storage device, determining an outcome for the wagering game based on the information contained in the outcome record, and dispensing value to the player in response to determining that at least one of the outcomes from the outcome records is a winning outcome.

### BACKGROUND

This invention relates to lottery systems for conducting pull-tab and other instant win lottery games and, more particularly, to gaming systems having pull-tab or other instant win lottery game outcomes downloaded to a portable storage device at purchase, and retrieved from the portable storage displayed and displayed and, if the outcomes are winning outcomes, paid off at redemption.

Various lottery and gaming systems are known for conducting electronic instant win games and other wagering games, and for determining outcomes of wagering games by selecting predetermined outcomes from a finite pool of outcomes for the wagering game. U.S. Pat. No. 5,324,035 to Morris et al. discloses a gaming system including a central game processor, a plurality of master processing units and a plurality of slave terminals operable by players to play the game. The central game processor communicates with the master processing units and supplies the various games available in the system. The master processing units store and administer the games as they are played on the slave terminals connected to each respective master processing unit. A preferred game includes a fixed pool of game plays and a predetermined number of winning plays within each pool. Each player, through his or her slave terminal, can purchase plays in each fixed pool stored in the master processing unit to which that terminal is coupled. When a particular pool is exhausted, for example, through the purchase of all plays, the central game processor provides another fixed pool of plays to that master processing unit to enable continuous play.

U.S. Pat. No. 4,582,324 to Koza et al. discloses a video amusement game terminal for a gaming system for playing a game providing the illusion of skill. A game processor provides a video game presentation in response to player control wherein a prize award is disclosed through presentation of achievement by the player of a designated objective. The presentation provides to the player the illusion that the prize award is determined by player skill in achievement of the designated objective.

As another example, U.S. Pat. No. 6,024,640 to Walker et al. discloses an off-line remote lottery system that enables players to purchase instant-type lottery game outcomes from a randomized prize datastream in a central computer and view the outcomes on remotely disposed gaming computers that do not require an on-line connection to the central computer during play. The central computer stores identification data for a plurality of gaming computers and is configured for randomly assigning outcomes from the randomized prize datastream to the gaming computers in response to purchase requests by players for a requested number of outcomes in each purchase request. Each gaming computer includes a game program in memory for execution on the gaming computer to generate games that yield the purchased outcomes or aggregate net payoff of the purchased outcomes, and a redemption function for generating a redemption request to cash-out winnings. The system enables outcome purchase and redemption of winnings to be effectuated directly with the central computer over a telephone network, or via a plurality of agent terminals located at various lottery retailers.

U.S. Patent Publication No. 2002/0039917 to Armstrong et al. discloses a computerized video game machine having a finite number of outcomes embodied in a computer readable tab cartridge that must be replenished after the total number of outcomes is exhausted. As each player plays the game, the number tabs playable is reduced by one and the play tab is analyzed as to whether it is a winning tab or not. If the tab is a winning tab then the symbols of the tab are compared to a look-up table to determine the payout that is then provided to the player. Once the tab is exhausted, the machine is no longer operable until the tab cartridges are recharged. The tab cartridges are recharged by electronic means by entering a reset code through input means such as touching buttons. Once the tab has been recharged then the machine will be able to be operable having the same number of tabs before the tabs were exhausted through play.

U.S. Patent Publication No. 2002/0082070 to Macke et al. discloses a ticket-manufacturing device to create populations of virtual tickets for use in a gaming environment. The device records these populations on removable updateable cartridges that will be used in the gaming environment. Further, it provides a secure method of managing the use of the ticket-manufacturing device. Further, the ticket-manufacturing device permits the collection of archive information about the played, redeemed and non-played tickets. Furthermore, the ticket-manufacturing device archives additional information that can be analyzed to increase knowledge of gaming facilities managers about the games.

Additionally, U.S. Patent Publication No. 2002/0111214 to Lind et al. discloses a lottery ticket distribution system including a ticket distribution center that is in electronic communication with a number of player terminals at locations remote to the ticket distribution center. The ticket distribution center includes an electronic ticket storage device for storing a game set of electronic tickets and distributing the electronic tickets to the player terminals. A ticket record manufacturing device operatively connected to the ticket distribution center provides either a nonvolatile data record for each ticket or a hard copy ticket, or both. The nonvolatile data records or set of hard copy tickets for a given game set are not distributed to the players, but are held for verification and dispute resolution purposes either at the ticket distribution center or some other secure location.

### SUMMARY OF THE INVENTION

In one aspect, the invention is directed to a gaming network for conducting an electronic wagering game wherein each player may purchase at least one outcome from a finite pool of outcomes for the wagering game. The gaming network may include a plurality of sales terminals and a plurality of redemption terminals. Each sales terminal may include a first input device for inputting a plurality of input selections, a second input device that may receive a portable storage device and that may be capable of reading data from the portable storage device and writing data to the portable storage device, a currency-accepting mechanism that may be capable of allowing a player to deposit a medium of currency, and a sales terminal controller that may be operatively connected to the first input device, the second input device, and the currency-accepting mechanism. Each redemption terminal may include a first redemption input device for inputting a plurality of input selections, a second redemption input device that may receive the portable storage device and that may be capable of reading data from the portable storage device and writing data to the portable storage device, a display device, a currency-dispensing mechanism that may be capable of dispensing a medium of currency, and a redemption terminal controller that may be operatively connected to the first redemption input device, the second redemption input device, the display device, and the currency-dispensing mechanism.

The sales terminal controller may be programmed to allow the currency-accepting mechanism to accept a deposit of an amount of a medium of currency by a player at the sales terminal, and to allow the first input device to receive input for a player's selections to purchase at least one outcome for the wagering game. The sales terminal controller may further be programmed to cause a selection device of the gaming network to select at least one outcome corresponding to the number of outcomes purchased by the player from the finite pool of outcomes, and to cause the second input device to store the selected outcomes on the portable storage device. The redemption terminal controller may be programmed to allow the first redemption input device to receive input for a player's request to redeem at least one outcome of the wagering game stored on the portable storage device, to cause the second redemption input device to read the outcomes requested by the player from the portable storage device in response to receiving the request by the player at the first redemption input device, and to display the outcomes read from the portable storage device at the display device. The redemption terminal controller may further be programmed to determine whether any of the outcomes from the portable storage device are winning outcomes, and to cause the currency-dispensing mechanism to dispense a game award to the player in response to determining that any of the outcomes from the portable storage device are winning outcomes.

In another aspect, the invention is directed to a method for conducting an electronic wagering game at a gaming network. The method may include selecting at least one outcome record from a finite pool of outcome records for the wagering game stored in the gaming network, storing the selected outcome records on a portable storage device, and distributing the portable storage device to a player. The method may further include receiving the portable storage device from the player at a redemption device of the gaming network, reading at least one outcome record from the portable storage device, determining an outcome for the wagering game based on the information contained in the outcome record, and dispensing value to the player in response to determining that at least one of the outcomes from the outcome records is a winning outcome.

In a further aspect, the invention is directed to a gaming network for conducting an electronic wagering game wherein each player may purchase at least one outcome from a finite pool of outcomes for the wagering game. The gaming network may include an outcome selection terminal and an outcome redemption terminal operatively connected to the gaming network. The outcome selection terminal may be configured to receive a portable storage device, and to read information from and to write information to a portable storage device received at the outcome selection terminal. Further, the outcome selection terminal may be configured to store outcome records selected from the finite pool of outcome records for the wagering game on a portable storage device received at the outcome selection terminal. The outcome redemption terminal may be configured to receive a portable storage device, and to read information from and to write information to a portable storage device received at the outcome redemption terminal. The outcome selection terminal may further be configured to read outcome records selected from the finite pool of outcome records for the wagering game stored on a portable storage device received at the outcome selection terminal, to determine outcomes for the wagering game based on the information contained in the outcome records read from a portable storage device, and to dispense value to a player in response to determining that at least one of the outcome records is a winning outcome.

Additional aspects of the invention are defined by the claims of this patent.

### BRIEF DESCRIPTION OF THE DRAWINGS

FIG. 1 is a block diagram of an embodiment of a networked lottery system.

FIG. 2 is a block diagram of the electronic components of an embodiment of the lottery terminal unit shown in FIG. 1.

FIG. 3 is a block diagram of the electronic components of an embodiment of the redemption terminal unit shown in FIG. 1.

FIG. 4 is a block diagram of the electronic components of an embodiment of the sales/redemption lottery terminal unit shown in FIG. 1.

FIG. 5 illustrates an embodiment of a portable storage unit in the form of a magnetic swipe card that may be read from and/or written to by the units of the networked lottery system of FIG. 1.

FIG. 6 illustrates an embodiment of a portable storage unit in the form of a smart card that may be read from and/or written to by the units of the networked lottery system of FIG. 1.

FIG. 7 is a flowchart of an embodiment of a game outcome purchasing routine for an electronic instant win game.

FIG. 8 is a flowchart of an embodiment of a game outcome redemption routine for an electronic instant win game.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

An electronic pull-tab or other instant win game as described herein may have application in lottery systems, casino gaming systems and in other systems wherein an instant win game may be integrated into the existing functionality of the system. An instant win game may be provided in addition to a lottery or casino game, and may be provided for no additional charge or for an additional wager placed by the lottery or casino player. Typical instant win games, such as scratch-off games, are based on multi-tier probability tables wherein each possible winning result for the game occurs in a predetermined percentage of all outcomes of the instant win game. For example, in a given instant win game, for a $1.00 wager the probability of having a $1.00 winning outcome may be 1 in 10 occurrences of the instant win game, while the probability of having a $100 winning outcome is significantly lower, such as 1 in 500 occurrences of the instant win game. These types of games typically have a finite pool of outcomes, with a known number of winning outcomes for each prize level. In this way, the amounts of the sales, prize distribution and profit are known to the sponsor at the time of the game's offering.

Traditionally, pull-tab and other instant win lottery games are offered on paper or cardboard tickets sold over-the-counter by sales agents at retail sales locations such as gas stations, convenience stores, beverage stores, grocery stores and the like, or from vending machines that may be located at these or other locations. It may be desired to automate the instant win lottery games by integrating the games into existing networks for conducting lotteries or other gaming. By doing so, the game's sponsor may be able to reduce some of the labor and costs associated with making, distributing and selling the tickets, and to enhance the entertainment value to the players through the use of graphics and other capabilities of an automated system.

In one embodiment, players may purchase one or more outcomes for a pull-tab or instant win lottery game, and the outcomes may be downloaded and stored on a portable storage device, such as a smart card or other card having a magnetic strip or other media capable of storing data, a USB key chip, portable flash memory, or the like. At the time the outcomes are sold to the player, the player may purchase the card with the outcomes from a sales agent at a lottery terminal unit, or from a kiosk at which the player may be able to enter the necessary information and payment to purchase the card and outcomes. After the outcomes are purchased and the player receives the storage device, the player may redeem the outcomes at a kiosk or other outcome display terminal connected to the lottery network and configured to read the outcomes stored on the portable storage device and to display the outcomes to the player. In order to ensure security for the game sponsor and for the player, the lottery network may include databases for the game and be configured to track the outcomes of the game as they are issued to and redeemed by the players, and may further include additional security measures for preventing outcomes from being redeemed off of the portable storage devices without necessary security information being supplied by the player or portable storage device at the time the player attempts to redeem the outcomes from the portable storage device.

### Lottery Network

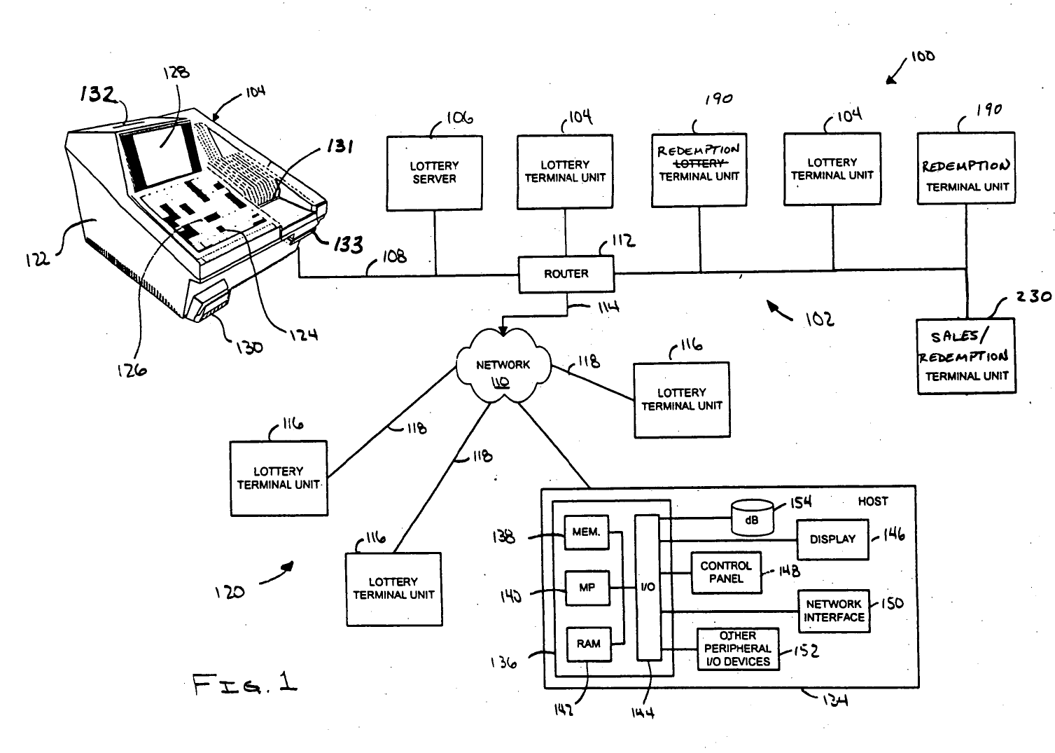

FIG. 1 illustrates one possible embodiment of a lottery network 100 that may implement electronic instant win games in addition to normal lottery-type games. Referring to FIG. 1, the lottery network 100 may include a first group or network 102 of lottery terminal units 104 operatively connected to a lottery network computer or server 106 via a network data link or bus 108. The lottery network 100 may be coupled to a network 110, which may be, for example, the Internet, a wide area network (WAN), or a local area network (LAN) through a network hub or router 112 via a first network link 114. In one possible configuration, the first network 102 may be a state lottery system operating within an individual state or region of states. In this configuration, the individual lottery terminal units 104 may be interconnected to a central system for tracking and coordination of the state lottery system, including issued tickets, drawn numbers, and/or amounts waged.

The lottery network 100 may further include other lottery terminal units 116 that may be directly connected to the network 110 through a plurality of direct network links 118, thereby eliminating the need for the bus 108, router 112 or other networking equipment. Each lottery terminal unit 116 in this configuration may represent a group of lottery retailers participating in the state lottery, as described above, or a plurality of the lottery terminal units 116 may be grouped together to form a lottery node 120. The lottery nodes 120, in turn, may be directly connected and/or multiplexed to the network 110 via the direct network links 118. Further, the direct network links 118 may represent secure communications channels physically hardened against tampering and/or the communications may be encrypted to prevent unauthorized access to information transmitted thereon.

FIG. 1 further illustrates a perspective view of one possible embodiment of a lottery terminal unit 104. Although the following description relates to the design of the lottery terminal unit 104 depicted in FIG. 1, it should be understood that the lottery terminal units 106 and 116 may include similar features or may be configured with functionality to allow the entry of the information required for a player to participate in a lottery game. The exemplary lottery terminal unit 104 may include a housing or casing 122, and one or more input and output devices, which may be, among other things, a control panel 124 having a plurality of input keys 126, a display 128, a value input device such as a card reader 130, a lottery play slip or ticket reader 131, a lottery ticket printer 132, and an instant game card reader/writer 133. The lottery play slip reader 131 may be configured to read bar codes, user selections, magnetically stored information or any other desired input information or media used to encode information on a play slip or lottery ticket.

The input keys 126 may allow the player or sales agent to select the game to be played, input the value to be wagered, manually enter the selected lottery characters, and input any other information necessary to play a given lottery game. The display 128 may be a LCD, a CRT, a touch-screen capable of receiving and displaying information, or any other suitable device capable of displaying the information input via the input keys 126, the lottery play slip reader 131 or the touch-screen input. The value input device may include any device that can accept value or a wager from a customer, such as the card reader 130 or an optical currency collector. The value input device may further be integrated with external devices, such as cash registers or other retail terminals, communicatively connected to the lottery terminal unit 104, to exchange information necessary to receive and record the wagering transactions. The lottery ticket printer 132 may be used to print or otherwise encode lottery tickets with information selected or required to play a given lottery game. Further, the lottery ticket printer 132 may provide lottery tickets, or even completed lottery slips if the selections were generated automatically, that could be used by the player in other lottery terminal units 116 equipped with lottery play slip or ticker readers 131.

The instant game card reader/writer 133 may be any device capable of receiving the portable storage devices on which the electronic instant win game is stored, and of reading information from and writing information to the storage media of the devices. For example, where the instant win game is implemented on cardboard, plastic or other cards having magnetic strips for storing information, the reader/writer 133 may be card reader/writer capable of retrieving information from the magnetic strip of the card and writing information to the magnetic strip. If the cards are configured in a similar manner as standard credit cards, the card reader 130 and card reader/writer 133 may be implemented in a single card processing unit with the card processing unit and the controller 160 being configured to perform the necessary processing for credit cards, debit cards, and the cards for the instant win game, depending on the type of card disposed therein. Where the instant win game may be implemented on smart cards, the card reader/writer 133 may be a smart card processing unit capable of reading information from and writing information to a microchip, circuit or other processing mechanism disposed on or embedded in the smart card. Further, where the portable storage device is USB key chip or a portable flash memory, the reader/writer 133 may be a USB connection to which the key chip or flash memory may be attached such that the controller 160 may read information from and write information to the key chip or flash memory through the USB connector. Other types of portable storage devices and corresponding read/write units may be implemented in the lottery network 100 and are contemplated as having use with the present invention.

The lottery terminal units 104, 116 and lottery nodes 120 may include centralized or shared display mechanisms such as scrolling digital signs or message boards configured to display the outcome of a completed lottery game and advertise or attract players to upcoming games. In one exemplary configuration, at least one lottery terminal unit 104 or 116 includes software for generating graphics and is communicatively connected to an external LCD suitable for displaying graphics. Upon completion of a lottery drawing, the results or winning information can be formatted by the graphical software and displayed, in an eye-catching manner, on the external LCD. Alternatively, the graphical software may be stored on a peripheral device, such as a CD-ROM, and the result of the lottery drawing communicated thereto for formatting and display.

The network 110, and hence the individual lottery terminal units 104 and 116, may be communicatively connected to a central host computer 134. The central host computer 134 may be a single networked computer, or a series of interconnected computers having access to the network 110 via a gateway or other known networking system. Generally, the central host computer 134 may include a central lottery controller 136 configured to manage, execute and control the individual lottery elements 104, 116 and 120 and the routines used to play the various lottery games. The central lottery controller 136 may include a memory 138 for storing lottery programs and routines, a microprocessor 140 (MP) for executing the stored programs, a random access memory 142 (RAM) and an input/output bus 144 (I/O). The memory 138, microprocessor 140, RAM 142 and the I/O bus 144 may be multiplexed together via a common bus, as shown, or may each be directly connected via dedicated communications lines, depending on the needs of the lottery system 100.

Further, the central lottery controller 136 may be directly connected, hardwired, or indirectly connected through the I/O bus 144 to external components such as a display 146, a control panel 148, a network interface device 150 and other peripheral I/O devices 152. Examples of other peripherals device include, but are not limited to, storage devices, wireless adaptors, printers, and the like. In addition, a database 154 may be communicatively connected to the central lottery controller 136 and provide a data repository for the storage and correlation of information gathered from the individual lottery terminal units 104, 116 or lottery nodes 120. The information stored within the database 154 may be information relating to individual lottery terminal units 104, 116 such as terminal specific information like a terminal identification code, sales agent code, and location for each lottery ticket printed. The database 154 may further include ticket specific information such as the type of game played (Lotto, Pick-3, Pick-4 etc.), or game specific information such as the total lottery sales, drawing outcomes, amounts wagered, numbers selected by the players, and the like.

In operation, the central lottery controller 136 may operate as a clearing-house for the lottery terminal units 116 and the first lottery network 102, whereby the lottery network computer 106 collects, stores and analyzes status and operational information relating to each lottery terminal unit 104. For example, the lottery network computer 106 may continuously receive transactional data from the individual lottery terminal unit 104 indicative of the number of tickets sold and associated dollar amounts, and the lottery numbers and number order generated at each lottery terminal unit. The transactional data collected by the lottery network computer 106 may be communicated to the central host computer 134 continuously or may be processed into a batch format and transmitted periodically for storage in the database 154. If, for example, the central lottery controller 136 and the lottery network computer 106 are communicating continuously, it may be desirable for the central lottery controller 136 to execute the actual lottery routine and transmit the results to the lottery network computer 106 for distribution to the lottery terminal units 104 and directly to the lottery terminal units 116. In addition, it may be desirable for the central lottery controller 136 to include, via the peripheral device input 152, a scanner, such as the lottery play slip reader 132, for directly importing/reading manual selections into the database 154.

It will be understood that the lottery network 100 illustrated in FIG. 1 may alternatively represent the network layout within a gaming establishment providing a lottery-type game. In this alternate configuration, each stand-alone lottery terminal unit 104 may be an interactive player terminal capable of playing a variety of lottery or casino games, such as a lottery game, Keno, Bingo, video poker, video blackjack, slots, and the like. The lottery terminal units 104 may be distributed throughout a single gaming establishment or casino and connected with a LAN, or throughout multiple casino sites and connected with a WAN. Further, the LAN and/or WAN connecting each of the lottery terminal units 104 may include one or more separate and secure buses 108, routers 112, web servers, gateways and other networking equipment to provide continuous and/or redundant connectivity to the network 110. The network 110, configured in this manner, provides a system for players to participate collectively in a centralized lottery-type game. Further, the network 110 may include express gaming stations at which players may generate predefined or automatically selected lottery tickets simply by making a selection and a wager. As discussed above, the network 110 may be communicatively connected to the central host computer 134, the central lottery controller 136, and the database 142 to allow for implementation, storage, tracking and analysis of the lottery game.

### Lottery Sales Terminal Unit

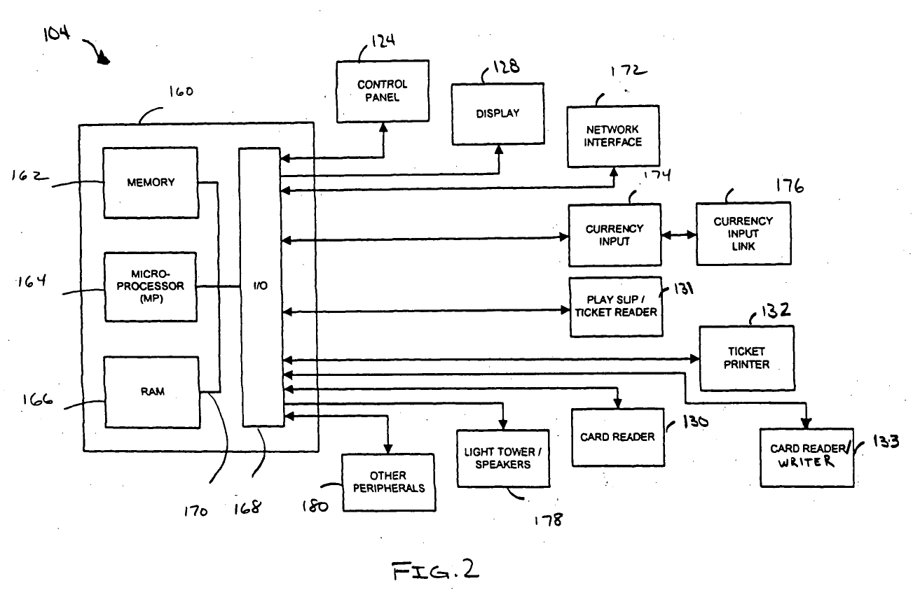

FIG. 2 illustrates a block diagram of an embodiment of the internal electronic components of the lottery sales terminal unit 104. The lottery sales terminal unit 116 may have the same or a different design, but may be configured to receive player entries into the lottery games and process winning lottery tickets. Referring to FIG. 2, the exemplary lottery terminal unit 104 may include a number of internal components such as a controller 160 having a program memory 162, a microcontroller or microprocessor (MP) 164, a random access memory (RAM) 166, and an input/output (I/O) bus 168, all of which may be interconnected via an address or data bus 170. It should be understood that while only one microprocessor 164 is shown herein, the controller 160 may be designed to support multiple microprocessors 164 arranged to operate in parallel or in any other known configuration. Similarly, the controller 160 may include multiple, and even redundant, program memories 162 and random access memories 166 to increase expandability, capacity and/or processing speed. The multiple processor and memory configurations may be used, for example, to isolate the individual lottery functions such as basic lottery operation, random number generation, information tracking, and the like. Although the I/O bus 168 is shown as a single addressable and integral block, it should be understood that direct I/O connections may be made, as well as any other desired I/O connection scheme. The program memory 162 and random access memory 166 may be implemented as a solid-state memory, an integrated circuit, a magnetically readable memory, and/or optically readable memories. Further, the program memory 162 may be read only memory (ROM) or may be read/write memory such as a hard disk. In the event that a hard disk is used as the program memory, the data bus 170 may comprise multiple address/data buses, which may be of differing types, and there may be a separate I/O circuit between the data buses.

FIG. 2 schematically illustrates that the controller 160 may be communicatively connected to the control panel 124, the display 128, the card reader 130, the lottery play slip or ticket reader 131, the lottery ticket printer 132, and the card reader/writer 133. The controller 160 may further be communicatively connected to a network interface card (NIC) or device 172, a currency input device 174 including a currency input link 176, and a light and speaker link 178. The network interface card 172 may be configured to allow the lottery terminal unit 104 to communicate information with other networked devices similarly connected to the network 110 using any known protocol or standard suitable for a lottery or network application. The currency input device 174 may be any kind of value input device such as the card reader 130 discussed above and/or bill and coin acceptors, or may include a currency input link 176 communicatively connected to a cash register (not shown) or other device for tracking and/or totaling currency or transactions. The light and speaker link 178 may be used to integrate visual and/or audio displays into the design of the lottery terminal unit 104.

FIG. 2 illustrates the components 124, 128-133, 162-166 and 172-180 directly connected the I/O bus 168 via dedicated circuits or conductors. However, it will be understood that different connections schemes may be used. For example, some of the components requiring limited communications with the controller 160 may be communicate via an auxiliary I/O bus (not shown) in a scheduled manner, while other components requiring fast communications or large data transfers may be directly connected to the I/O bus 168. Furthermore, depending on the needs of the system, some of the components may be directly connected to the microprocessor 164 without having to pass through the I/O bus 168.

### Lottery Redemption Terminal Unit

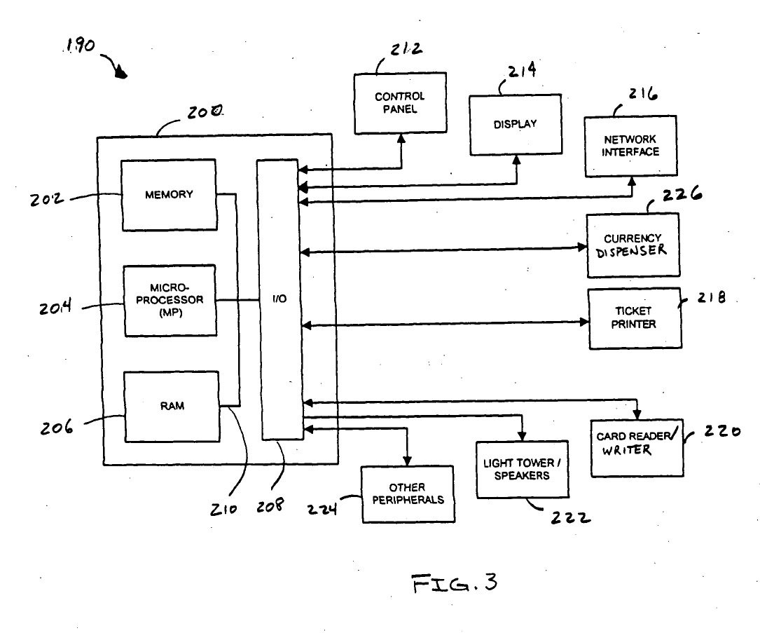

Returning to FIG. 1, the lottery network 100 may further include a plurality of lottery redemption terminal units 190 at which players may insert or otherwise attach the portable storage device and redeem the outcomes of the instant win game stored thereon. The redemption terminal units 190 may be stand alone terminals or kiosks that may be approached and operated by the players without the necessity of a separate operator or agent of the sponsor, and may be placed in numerous locations within the area in which the instant lottery game is offered. FIG. 3 illustrates a block diagram of an embodiment of the internal electronic components of the lottery redemption terminal unit 190. The exemplary redemption terminal unit 190 may include a number of internal components similar to those described for the lottery sales terminal units 104, 116 and the central host computer 134, such as a controller 200 having a program memory 202, a microcontroller or microprocessor (MP) 204, a RAM 206, and an I/O bus 208, all of which may be interconnected via an address or data bus 210. The controller 200 may be designed to support multiple microprocessors 204 arranged to operate in parallel or in any other known configuration, and may include multiple, and even redundant, program memories 202 and random access memories 206 as previously discussed in relation to controllers 136, 160, and the I/O bus 208 may have direct I/O connections or any other desired I/O connection scheme. The program memory 202 and random access memory 206 may be implemented using any appropriate storage technology such as, for example, those previously described herein.

FIG. 3 schematically illustrates that the controller 200 may be communicatively connected to a control panel 212, a display 214, a network interface card or device 216, a ticket printer 218, a card reader/writer 220, lights and speakers 222 and other peripherals 224 in a similar manner as previously described for the sales terminal units 104. The components 212-224 may be similar in configuration and operation as similar components previously described, and may be configured in any manner necessary for redemption of the outcomes of the instant win game by the player. For example, the control panel 212 may include the necessary input devices to allow the player to enter information for redeeming the outcomes, such as security information and input selections necessary to redeem the outcomes and to have the outcomes displayed at the display 214. As an alternative or a supplement for inputting information at the redemption terminal unit 190, the display 214 may be a touch-screen monitor allowing players to touch designated areas of the display 214 to enter any necessary information, with the selections or other information input by the players being communicated to the controller 200.

Because the outcomes are evaluated and prizes may be determined and issued at the redemption terminal units 190, the units 190 may further include one or more currency dispensers 226 configured to dispense the awards for the instant win game to the players in a particular medium of currency. For example, the currency dispenser 226 may be bill and/or coin dispenser from which paper and/or coin currency may be dispensed in an amount equal to the award won by the player. The currency dispenser 226 may alternatively be a card reader and/or writer that may read a credit or debit card in order to credit the player's account with the award amount, or to update the smart card or other game card with a cash credit, or credits toward purchasing additional outcomes for the instant win game. As a further alternative, the currency dispenser 226 may be the ticket printer 218 or other printer that may print and dispense a voucher or receipt that may then be taken to a cashier or other sales agent, perhaps at one of the sales terminal units 104, to claim the cash amount of the game award.

FIG. 3 illustrates the components 202-206 and 212-226 directly connected the I/O bus 208 via dedicated circuits or conductors. However, it will be understood that different connections schemes may be used. For example, some of the components requiring limited communications with the controller 200 may be communicate via an auxiliary I/O bus (not shown) in a scheduled manner, while other components requiring fast communications or large data transfers may be directly connected to the I/O bus 208. Furthermore, depending on the needs of the system, some of the components may be directly connected to the microprocessor 204 without having to pass through the I/O bus 208.

### Lottery Sales/Redemption Terminal Unit

In some implementations, it may be desired to allow the players to purchase outcomes for the electronic instant win game directly instead of from at sales agent at a lottery sales terminal 104, 116. In these implementations, the lottery sponsor may provide kiosks or other terminals allowing players to walk up, make their selections for the instant win game, and deposit currency or use a credit card to purchase the outcomes. A lottery sales/redemption unit 230 may be implemented in the lottery network 100 of FIG. 1. FIG. 4 illustrates a block diagram of an embodiment of the internal electronic components of the lottery sales/redemption terminal unit 230. Because the sales/redemption terminal unit 230 performs the same functions as the lottery sales terminal units 104, 116 and the lottery redemption terminal units 190, the sales/redemption terminal 230 may include components 240-270 that may be similar to the corresponding components of the sales terminal units 104, 116 and redemption terminal units 190 as previously described, such that the players may both purchase and redeem outcomes for the instant lottery game at the sale/redemption terminal units 230. Further, the components 240-270 may be operatively connected in any desired manner, such as the configurations previously described above.

### Portable Storage Devices

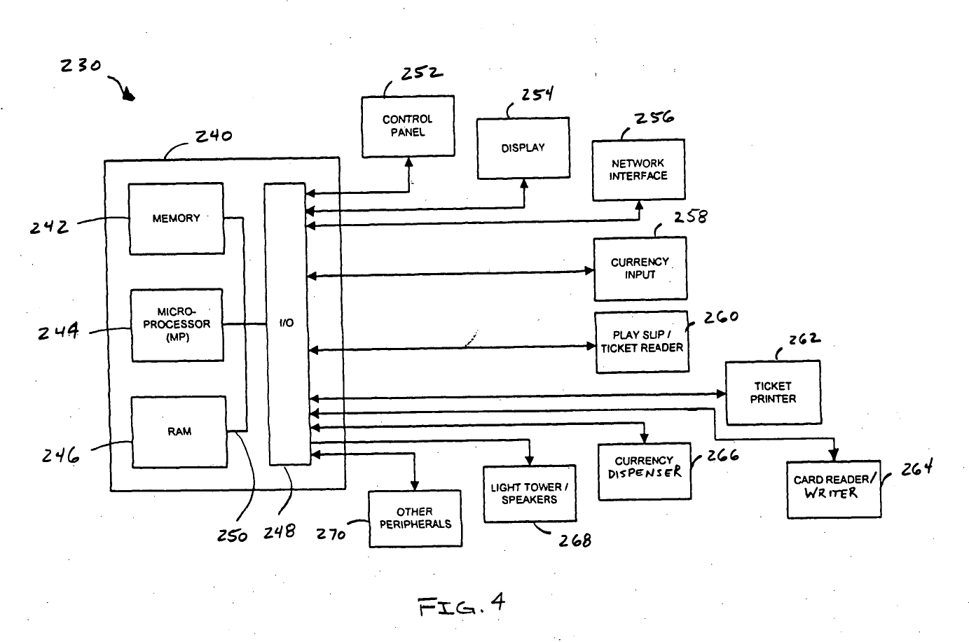

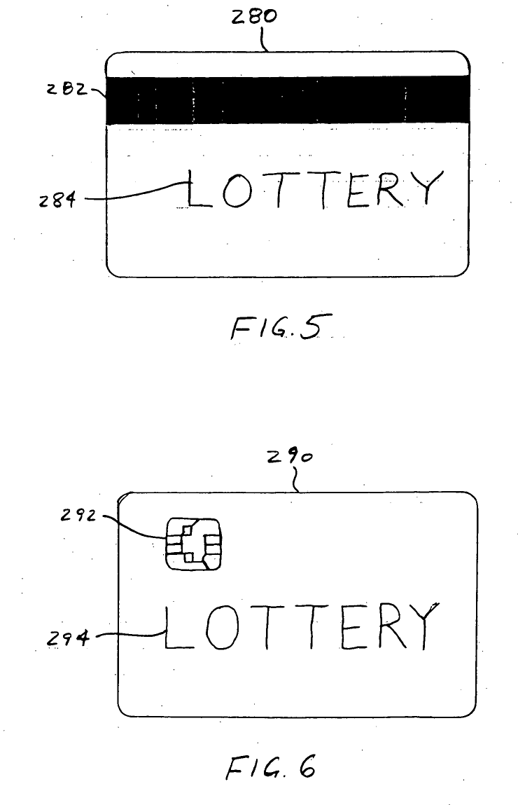

As previously discussed, the electronic instant win game may be implemented in the lottery network 100 using portable storage device on which the instant win game outcomes may be written when purchased by the players, and from which the outcomes may be read when redeemed by the players. It is contemplated that the particular portable storage device implemented for an instant win game may be that which is capable of providing the necessary storage capacity, processing capabilities and security features to meet the needs and objectives of the game's sponsor. FIGS. 5 and 6 illustrate examples of such portable storage devices. Referring to FIG. 5, the portable storage device may be in the form of a card 280 having a magnetic strip 282 disposed on a surface thereof, and indicia 284 printed thereon for identification of the card 280 as a portable storage device for the electronic instant lottery game. Information for the game, such as the outcomes of the game, player identification and other security information, and the like, may be written to the magnetic strip 282 by the card reader/writers 133, 264 at the time the outcomes are purchased at units 104, 230, and the magnetic strip 282 may be read, updated and/or erased at the card reader/writers 220, 264 when the outcomes are redeemed at the terminal units 190, 230. The information contained on the magnetic strip 282 may be used by the units 104, 106, 190, 230 to perform the processing for the instant win game, but may not be able provide additional processing capabilities, such as processing that may be necessary for game security.

FIG. 6 illustrates an alternative embodiment of a portable storage device in the form of a smart card 290. The smart card 290 may be fabricated from any appropriate material, and may include a microchip 292 or other micro-processing device embedded therein or disposed on a surface thereof. Information for the game, such as the outcomes of the game, player identification and other security information, and the like, may be written to the microchip 292 by the card reader/writers 133, 264 at the time the outcomes are purchased at units 104, 116, 230, and the microchip 292 may be read, updated and/or erased at the card reader/writers 220, 264 when the outcomes are redeemed at the terminal units 190, 230. In addition to providing storage for the game outcomes and related information, the microchip 292 may have its own processing capabilities that may be configured to assist in the execution of the outcomes of the instant win game, to provide some or all of the processing for any implemented security measures, or to provide any other processing necessary and/or desired for executing the electronic instant win game. The card read/writers 133, 220, 264 may be smart card readers adapted to communicate with the microchip 292 of the smart card 290 inserted therein to exchange information and to perform processing. The controllers 160, 200, 240 and/or the card reader/writers 133, 220, 264 may include software or be otherwise configured to read and write and to perform game logic and security processing in conjunction with the processing capabilities of the microchip 292 to execute the instant win game stored thereon and perform any necessary security checking for validation and tamper integrity of the smart card 290 and the outcomes stored thereon.

As previously discussed, other portable storage devices, such as USB key chips, portable flash memories and the like, may be used to implement the electronic instant win game in a lottery network 100. Those skilled in the art will be capable of implementing the portable storage technologies with the electronic instant win game and, therefore, more detailed discussion of the various technologies is not provided herein.

### Purchasing Instant Win Game Outcomes

The process for purchasing instant win game outcomes and storing the outcome records on a portable storage device will now be discussed with regard to the purchase game outcomes routine 300 illustrated in FIG. 7. The purchase game outcomes routine 300 may begin at a block 302 wherein a portable storage device for the electronic instant win game may be inserted into or attached to a read/write device, such as card reader/writers 133, 264, at one of the sales terminal units of the lottery network 100. If the player of the instant win game already possesses a portable storage device for the electronic instant win game, the player may hand the portable storage device to a sales agent who in turn may insert the storage device into or connect the storage device to one of the terminal units 104, 106, or the player may approach a sales/redemption terminal 230 (if implemented) and insert or attach the storage device. If the player does not already possess a storage device for the instant win game, the sales agent may have a supply of portable storage devices on hand at the sales location, and may select one of the available portable storage devices, and insert or attach the selected portable storage device. In an alternative embodiment where the portable storage devices are magnetic strip cards, smart cards or the like, the card reader/writers 133, 264 may include a card dispenser unit and storage bin of the type known to those skilled in the art. A plurality of cards may be stacked in the storage bin, and the card dispenser unit may pull one of the cards from the storage bin and load the card into position within the card reader/writer 133, 164 so that the card reader/writer 133, 164 read from and write to the storage medium of the card in response to a sales agent or player requesting a new card at the control panel 124, 252 or other input device of the terminal units, 104, 106, 230.

Once the portable storage device is inserted or attached at the sales terminal, control may pass to a block 304 wherein the sales agent (at terminal unit 104, 106) or the player (at sales/redemption terminal unit 230) may input information for the game options for purchasing the type and amount of game outcomes desired by the player. The information may be input at the control panel 124, 252 or other input device of the terminal units 104, 106, 230. Depending on the implementation of the instant win game(s) in the lottery network 100, the player may be provided with a plurality of options for purchasing instant win game outcomes. For example, players may be offered the opportunity to select one or more of a plurality of instant win games offered by the lottery sponsor and made available on the lottery network 100, to select a purchase denomination for an instant win game where a given instant win game is offered with differing denomination and corresponding award amounts, to select the number of outcomes of the instant win game to be purchased, and to make any other available selections.

When the selections are entered, the corresponding controller may validate the game option selections and cause the display 128, 254 or other display device of the terminal units 104, 106, 230 to display the selections or a summary thereof to the sales agent or the player. The terminal units 104, 106, 230 may then provide the sales agent or player with the option to modify the game option selections or confirm the existing selections. After the game options selections are entered and confirmed, control may pass to a block 306 wherein the player may deposit the value necessary to purchase the instant win game outcomes specified in the game option selections. The value deposited to purchase the outcomes may be in any appropriate form to be accepted by the lottery network 100 in exchange for the purchased outcomes. For example, the value may be monetary in the form of paper or coin currency given to the sales agent or deposited at the terminal units in currency inputs 174, 258 in the form of bill or coin acceptors, or credit or debit cards read by card readers 130, 264. Alternatively, the lottery network 100 may be configured to provide player tracking functionality as is known in the art, which may include the provision of a drawing account with previously-deposited funds, electronic funds transfer, automated debiting of bank accounts or credit cards, or any other automated mechanism for obtaining value to pay for the purchased outcomes. Still further, the value may be in the form of a voucher having a cash or credit value that may be read by ticket reader 131, 260, with the associated value being applied to the purchase of the game outcomes. Moreover, in some implementations, the portable storage device may store information pertaining to cash or credit value, such as credits toward the purchase of additional outcomes, that may be retrieved when the storage device is inserted or attached at the reader/writers 133, 264 and applied to the purchase, with the portable storage device being updated to reflect the redemption of the cash or credit value.

In the illustrated embodiment, once sufficient value is deposited for the outcomes to be purchased based on the game option selections, control may pass to a block 308 wherein the outcomes to be purchased and provided to the player may be selected from a pool or pools of available outcomes for instant win game or games selected by the player. The outcomes may be selected from the pool randomly, sequentially or by any other desired method for selecting one or more outcomes from the pool. As previously discussed, each instant win game may have a finite pool of known outcomes including a predetermined combination of winning and non-winning outcomes that will yield a desired income and payout rate for the instant win game. The pool of outcomes for the instant win game may reside at any desired location or locations within the lottery network 100 such that the selected outcomes may be provided to the lottery terminals 104, 106, 230 for sale to the players.

Many strategies for generating finite pools of outcomes for wagering games and distributing the outcomes to gaming units with a gaming network are known in the art. In a simple implementation, the finite pool of outcomes may be generated and stored at a central computer of the lottery network 100, with the central computer selecting the necessary number of outcomes from the pool in response to a request transmitted by one of the terminal units 104, 106, 230, and transmitting the selected outcomes to the requesting terminal unit 104, 106, 230. In other implementations, the outcome pools or portions of outcome pools may be distributed to host computers 134 and/or directly to the gaming units 104, 106, 230 where the outcomes may be selected when requested.

One example of a gaming network wherein outcomes for a finite pool wagering game are distributed in a gaming network is disclosed in U.S. Pat. No. 5,324,035, issued on Jun. 28, 1994 to Morris et al., entitled “Video Gaming System with Fixed Pool of Winning Plays and Global Pool Access.” Morris et al. discloses a gaming system including a central game processor, a plurality of master processing units and a plurality of slave terminals operable by players to play the game having a finite pool of outcomes. The central game processor communicates with the master processing units and supplies the various games available in the system, including fixed pools of outcomes. The master processing units store and administer the wagering games as they are played on the slave terminals corresponding to each respective master processing unit. Some of the wagering games include fixed pools of game outcomes and a predetermined number of winning outcomes within each pool. A player, through a slave terminal, can purchase plays in each fixed pool stored in the master processing unit to which that terminal is coupled. When a particular pool is exhausted, for example, through the purchase of all plays, the central game processor provides another fixed pool of plays to that master processing unit to enable continuous play. Other methods for distributing outcomes for the instant win games are known and will be apparent to those skilled in the art, and are contemplated as having use with the electronic instant win game in accordance with the present invention.

The outcome records for the instant win game stored and retrieved from the pools of outcomes may include the information necessary for conducting the electronic instant win game, and for ensuring the security and integrity of the game. The information relating to the actual outcome may be in any form necessary based on the configuration of the instant win game for storing the outcome and generating the outcome at the terminal units 190, 230 at redemption. For example, the information may correspond to the actual outcome of the instant win game, such as specifically indicating the game symbols or other game indicia for the outcome. Alternatively, the outcome information may be in the form of an outcome seed or other information as is known in the art that may be processed by the terminal units 190, 230 to arrive at the outcome of the instant win game. In one embodiment, the outcome information may be a random number seed that may be used as input to corresponding random number generation software at the terminal units 190, 230 that uses the random number outcome to generate the outcome for the instant win game. An example of a gaming network implementing random number seeds to generate outcomes at gaming terminal is disclosed in U.S. Pat. No. 6,533,664, issued on Mar. 18, 2003 to Crumby, entitled “Gaming System with Individualized Centrally Generated Random Number Generator Seeds,” the specification of which is expressly incorporated by reference herein. The use of the random number seeds and other coded information in the outcome record may improve the security of the game by making it more difficult to generate an outcome record outside the lottery network 100 that may be correctly processed by the lottery network 100. Other forms of outcome information for transmitting the outcome and performing processing to generate the outcome are known in the art and are contemplated as having use with the instant win game in accordance with the present invention.

The outcome records may include additional information for identification and security within the electronic instant win game. The records may include information relating to the instant win game to which the outcomes correspond, such as identification information for the instant win game, denomination information where the same instant win game may be offered in different purchase denominations, or other necessary or desire identification information. The records may further include audit control and security information for verifying the integrity of the outcomes and the instant win game. Such information may include a control number for tracking the outcomes, such as a timestamp or other unique identifier, identification of the pool and/or component of the lottery network 100 from which the outcome was drawn, or any other information for tracing and confirming the validity of the outcome record as the record is processed in the lottery network 100.

Once the outcomes are selected and, if necessary, transmitted to the requesting terminal unit 104, 106, 230, accounting and control information, and other security information for the instant win game may be updated at a block 310. At block 310, the information in the lottery network 100 may be updated to reflect the selection and the issuance of the outcome records from the pool of outcomes. The outcome record within the pool may be updated to reflect the selection of the outcome and to prevent the outcome record from being selected a second time. For example, the outcome record may include a status indicator having one value indicating availability for selection, another value indicating previous selection of the outcome record, and possibly another value indicating that the outcome has been redeemed that may be set after the player redeems the outcome as described in greater detail below. If desired or necessary, the outcome record may further be updated with identification information relating to the terminal unit 104, 106, 230 at which the outcome record was purchased, and relating to the portable storage unit and/or the player to which the outcome was issued. The storage unit and player information may be used at redemption to verify that the player and storage unit redeeming the outcome record correspond to those identified in the outcome record in the pool. Other necessary accounting information necessary for administering the instant win game may also be update where necessary within the lottery network 100.

Once the outcome records are retrieved and the accounting, control and security information are updated, control may pass to a block 312 wherein the selected outcome records are downloaded and written to the portable storage unit. The controller 160, 240 of the terminal unit 104, 106, 230 may cause the reader/writer 264 to store the records on the portable storage device. As with outcome records in the outcome pool, the outcome records stored on the portable storage device may include a status indicator identifying the outcome record as being available to be redeemed.

In addition to the outcome records, additional security information may be input at the terminal unit 104, 106, 230 and stored in the lottery network 100 and/or the portable storage device to ensure that the player purchasing the outcomes and using the portable storage device is the same player that later redeems the outcomes. As previously discussed, the portable storage unit may include a unique identifier that may be stored on the outcome record in the outcome pool and later verified against the record in the outcome pool at redemption of the outcome. In other embodiments, each player may be assigned an identification number and associated password that may allow access to the lottery network 100 to purchase and redeem instant win game outcomes. In one embodiment, the player's identification number and password may be stored at a secure location within the lottery network 100, and the player's identification number may be written onto the portable storage device at the time the player makes an initial purchase of instant win game outcomes with the portable storage device. When the portable storage device is used to redeem outcomes stored thereon at a later time as described below, the player may be required to enter a password, and the identification number stored on the portable storage device and the password entered at the terminal unit 190, 230 may be compared to the stored identification number and password to confirm that the correct password has been entered.

In other alternative embodiments, the outcome records may be stored on the storage device in a format that may only be accessed after the player provides necessary validation information to allow a read/write device to read and convert the information. For example, the controllers 160, 240 of the terminal units 104, 106, 230 may be programmed to encrypt the outcome records, and then transmit the encrypted outcome records to the reader/writers 133, 264 for downloading to the portable storage devices. Depending on the processing capabilities of the portable storage devices, the portable storage devices may be programmed with logic to be executed as part of the encryption and decryption processes. The portable storage device may include an associated decryption key, or a decryption key may be issued at the time of the purchase transaction, that may be disclosed to the player, and that may be required to be entered at the time the instant win game outcomes are redeemed. Other security mechanisms for restricting access to lottery network 100 and/or to the information stored on the portable storage devices are known to those skilled in the art and are contemplated as having use with the electronic instant win game in accordance with the present invention.

Once the outcome records are purchased, information in the lottery network 100 is updated and the outcome records are written to the portable storage device, the portable storage device may be dispensed or otherwise removed from the terminal unit 104, 106, 230 at a block 314 to conclude the purchase transaction. The portable storage device may then be used at a redemption terminal unit 190, 230 to redeem the stored outcomes as described more fully below. Depending on the desired implementation of the lottery network 100 and the statutory requirements of the jurisdiction in which the instant win game is offered, it may be necessary to remove the portable storage device from the combination sales/redemption terminal units 230 at the end of the purchase transaction even though the terminal units 230 may have the capability of both selling and redeeming the outcomes, as some jurisdictions may require the physical dispensing of the portable storage device between the purchase and redemption transactions.

The flow of the purchase game outcomes routine 300 is exemplary only, and the steps may be performed in any order necessary to complete the purchase transaction. For example, a player may be required to deposit value at the terminal unit 306 prior to receiving a new portable storage device or to inputting game option selections. Moreover, based on system communication and processing requirements, accounting and security information may be partially updated during the purchasing transaction, and partially updated at a later time via background batch processing. Still further, updating of the portable storage device with access and security information may be performed at the outset of the transaction, such as at the initial use of a given portable storage device. Additionally, the timing and the location at which the steps of the purchasing routine 300 are performed may vary. In one embodiment, the portable storage devices may be in the form of prepaid cards that may be purchased by the players with outcomes records already loaded thereon. The selection of the outcome records, updating of information and downloading of the outcome records to the prepaid cards may occur at a central location, and the players may then deposit value a receive one of the prepaid cards from a sales agent or at a purchasing terminal unit out in the field.

### Redeeming Instant Win Game Outcomes

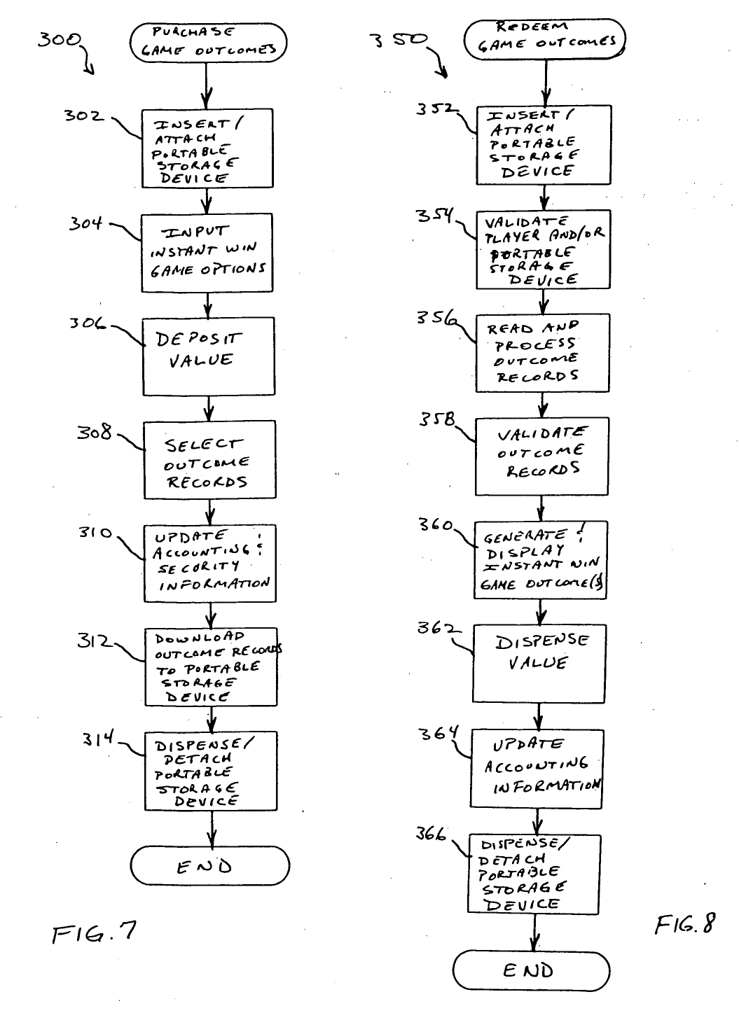

Armed with the portable storage device with instant win game outcomes stored thereon, a player may approach a terminal unit 190, 230 at which the outcomes may be redeemed. FIG. 8 illustrates on embodiment of a game outcome redemption routine 350 that may occur when the player redeems game outcomes from the portable storage device at the terminal unit 190, 230. The routine 350 may begin a block 352 with the player inserting or otherwise attaching the portable storage device to the redemption terminal unit 190, 230 at a device such as the card reader/writers 220, 264. The terminal unit 190, 230 may detect the insertion or attachment of the portable storage device, or otherwise receive input indicating that a player has approached the terminal unit 190, 230 to redeem instant win game outcomes, and control may pass to a block 354 where the player and/or the portable storage device may be validated for access to the lottery network 100 and to the data stored on the portable storage device.

Depending on the specific implementation of the instant win game and lottery network 100, the validation may be performed using information from the portable storage device and/or input by the player at the terminal unit 190, 230. The portable storage unit may store identification information or other information indicating that the portable storage unit is intended and authorized for use in the lottery network 100. Additionally or alternatively, the player may input information necessary to access the lottery network 100 and redeem the outcomes. As discussed in an earlier example, the lottery network 100 may be configured such that each player is assigned a unique identification number and password, in which case the player may be required to enter the information at the control panel 212, 252 or other input device of the terminal unit 190, 230. The player may also be required to enter information, such as a decryption key as discussed above or other information associating a particular player with a particular portable storage device, for access to the data stored on the portable storage device. The controller 200, 240 and other components of the lottery network 100 may be configured to use information from the portable storage device and/or the player to perform the necessary access and security validation processing to allow a player with the proper information to continue with the game outcome redemption routine.

After the access and security validation are performed at block 354 and the player and portable storage device are determined to be valid, control may pass to a block 356 wherein the outcome record or records are read from the portable storage device and processed by the terminal unit 190, 230. The terminal units 190, 230 may be configured to read the outcome records from the portable storage device without further input from the player, or may prompt the player to enter additional information regarding when to read the outcome records, which outcome records to read, such as when multiple instant win games are offered and the portable storage device may store outcome records for different instant win games, how many of the outcome records to read, and the like.

The format of the outcome records may dictate the amount of processing required to convert the information from the outcome records into the corresponding outcomes for the instant win game. Where information corresponding to the symbols for the instant win game is stored in the outcome record, the terminal unit 190, 230 may only be required to look up the symbols and compare the combination of symbols to predetermined winning combinations of symbols to determine whether the outcome is a winning outcome. In some implementations, the outcome record may include an identifier for the corresponding record in the outcome pool, and the controller 200, 240 of the terminal unit 190, 230 may transmit a request for the outcome to the device at which the pool is stored, with the device responding with additional information for the outcome. Still further, where the outcome record contains a seed such as a random number generator seed as discussed above, the controller 200, 240 may input the seed into the random number or other outcome generating software to generate the corresponding outcome for the instant win game. Other methods for converting an outcome record from a pool of outcome records into the actual outcome for a wagering game are known in the art and are contemplated as having use in the electronic instant win game in accordance with the present invention.

In addition to reading and processing the outcome records, the outcome records read from the portable storage device may be validated at a block 358. The necessary validation processing may be determined based on the information in the outcome records and on the portable storage device, and on the information stored in the lottery network 100. As mentioned above, each outcome record may contain a record identifier. The record identifier may be checked against corresponding records in the outcome pool, or may be checked for characteristics required for the validity of the identifier itself, such as having a proper check digit or satisfying other check-sum or redundancy checking logic. The validation may also include verification that the outcome record is being redeemed from the same portable storage device, and/or by the same player, to which the outcome record was issued. When the outcomes are purchased, the identifiers for the portable storage device and/or the player may be stored in the corresponding outcome record in the outcome pool, or in another location within the lottery network 100, that may be queried when the outcome record is read from the portable storage device.

Once the outcome records are read from the portable storage device, and processed and validated by the lottery network 100, control may pass to a block 360 wherein the instant win game outcomes may be displayed to the player. The controller 200, 240 may cause the display 214, 254 or other display device at the terminal unit 190, 230 to display a graphical representation of the outcome of the instant win game. The particular graphical representation may relate to the instant win game being played, and include any symbols, active and interactive graphics or other information desired to be presented by the lottery sponsor for displaying the outcome of the instant win game in an informative and entertaining manner for the players. The display may be as simple as a textual indication of the outcome and any associated awards, or may be more complex and include interactive graphics simulating the playing of a corresponding physical version of the instant win game, or simulating other games or activities, the end result of which yields the outcome for the instant win game. For example, for an electronic instant win game corresponding to a physical scratch-off game, the display may include graphics representing the covered spaces of the scratch-off game, with the player inputting information for the selection of spaces to be uncovered. As the spaces are selected, the cover graphics may change to game symbols displayed in combinations corresponding to the outcome of the instant win game from the outcome record. In other embodiments, the display may simulate other wagering games, such slots or draw poker, with the displayed outcomes of the wagering games corresponding to and being determined by the outcome from the outcome record. Other graphical presentations of instant game outcomes are known and/or will be apparent to those skilled in the art and are contemplated as having use in an electronic instant win game in accordance with the present invention.

If the instant win game outcome or outcomes are winning outcomes, value may be dispensed to the player at a block 362. The terminal units 190, 230 may be configured to dispense value to players in any acceptable form as dictated by the lottery sponsor. Value may be dispensed in the form of paper and/or coin currency dispensed from the currency dispenser(s) 226, 266 of the terminal unit 190, 230. Value may also be dispensed to the player in the form of a paper coupon or voucher printed and dispensed at ticket printer 218, 262 that may be redeemable for cash, or for goods or services offered by the lottery sponsor or its affiliates in an amount equivalent to the award or awards won by the players from the instant win game outcomes. Value may alternatively be dispensed in the form of monetary credit or game credits that may be stored on the portable storage device, or in the player's information on a player tracking system of the lottery network 100. A plurality of these and other for value dispensing options may be provided to the players, with the player's being capable of input selections regarding the form in which to receive the value of the awards won for the outcomes of the instant win game.

As the outcomes are processed and any corresponding awards are dispensed to the players, corresponding accounting information in the lottery network 100 may be updated at a block 364. As outcomes are processed from the portable storage device, the outcome records stored on the portable storage device may be updated to reflect their redemption, such as by updating status information or deleting the redeemed outcome records altogether. At the same time, the redemption terminal unit 190, 230 may transmit a message to the device storing the corresponding pool of outcomes to update the status of the corresponding outcome records to reflect their redemption. Additional accounting and audit trail information, such as amount of awards paid out, number of outcome records redeemed and the like, relevant to the instant win game and stored in the lottery network 100 may be updated as appropriate. Once the outcome records are redeemed and any corresponding award amounts are dispensed, or at the request of the player via input at the redemption terminal unit 190, 230, the portable storage device may be dispensed or otherwise removed from the redemption terminal unit 190, 230 at a block 366 for future use in purchasing and redeeming outcomes for the instant lottery game. In a similar manner as discussed above with respect to the purchase game outcome routine 300, the step of the game outcome redemption routine 350 may occur in any order necessary or desired to implement the electronic instant win game.

While the preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

What is claimed is:

1. A gaming network for conducting an electronic wagering game wherein each player may purchase at least one outcome from a finite pool of outcomes for the wagering game, the gaming network comprising:
a plurality of sales terminals, each sales terminal comprising:
a first input device for inputting a plurality of input selections,
a second input device for receiving a portable storage device, the second input device being capable of reading data from the portable storage device and writing data to the portable storage device,
a currency-accepting mechanism that is capable of allowing a player to deposit a medium of currency, and
a sales terminal controller operatively coupled to the first input device, the second input device, and the currency-accepting mechanism; and
a plurality of redemption terminals operatively coupled to the sales terminals, each redemption terminal comprising:
a first redemption input device for inputting a plurality of input selections,
a second redemption input device for receiving the portable storage device, the second redemption input device being capable of reading data from the portable storage device and writing data to the portable storage device,
a display device,
a currency-dispensing mechanism that is capable of dispensing a medium of currency, and
a redemption terminal controller operatively coupled to the first redemption input device, the second redemption input device, the display device, and the currency-dispensing mechanism;
the sales terminal controller being programmed to allow the currency-accepting mechanism to accept a deposit of an amount of a medium of currency by a player at the sales terminal,
the sales terminal controller being programmed to allow the first input device to receive input for a player's selections to purchase at least one outcome for the wagering game,
the sales terminal controller being programmed to cause a selection device of the gaming network to select at least one outcome corresponding to the number of outcomes purchased by the player from the finite pool of outcomes,
the sales terminal controller being programmed to cause the second input device to store the selected outcomes on the portable storage device,
the redemption terminal controller being programmed to allow the first redemption input device to receive input for a player's request to redeem at least one outcome of the wagering game stored on the portable storage device,
the redemption terminal controller being programmed to cause the second redemption input device to read the outcomes requested by the player from the portable storage device in response to receiving the request by the player at the first redemption input device,
the redemption terminal controller being programmed to display the outcomes read from the portable storage device at the display device,
the redemption terminal controller being programmed to determine whether any of the outcomes from the portable storage device are winning outcomes, and
the redemption terminal controller being programmed to cause the currency-dispensing mechanism to dispense a game award to the player in response to determining that any of the outcomes from the portable storage device are winning outcomes.

2. A gaming network for conducting an electronic wagering game according to claim 1, wherein the sales terminal controller is programmed to cause the second input device to dispense the portable storage device to the player after storing the outcome records on the portable storage device.

3. A gaming network for conducting an electronic wagering game according to claim 1, wherein the sales terminal and the redemption terminal are the same device.

4. A gaming network for conducting an electronic wagering game according to claim 1, wherein the portable storage device has portable storage device identification information stored thereon,
the sales terminal controller being programmed to cause the selection device of the gaming network to store the portable storage device identification information with the outcome record in the finite pool corresponding to an outcome record selected and stored on the portable storage device,
the redemption terminal controller being programmed to cause the selection device of the gaming network to compare the portable storage device identification information stored on the portable storage device to the portable storage device identification information stored in the corresponding outcome record in the finite pool in response to reading an outcome record from the portable storage device, and
the redemption terminal controller being programmed to determine whether the outcome from the portable storage device is a winning outcome in response to determining that the portable storage device identification information stored on the portable storage device matches the portable storage device identification information stored in the corresponding outcome record in the finite pool.

5. A gaming network for conducting an electronic wagering game according to claim 1, the sales terminal controller being programmed to allow the first input device to receive player identification information from the player,
the sales terminal controller being programmed to cause the selection device of the gaming network to store the player identification information with the outcome record in the finite pool corresponding to an outcome record selected and stored on the portable storage device,
the redemption terminal controller being programmed to allow the first redemption input device to receive player identification information from the player,
the redemption terminal controller being programmed to cause the selection device of the gaming network to compare player identification information input by the player at the first redemption input device to the player identification information stored in the corresponding outcome record in the finite pool in response to reading an outcome record from the portable storage device, and
the redemption terminal controller being programmed to determine whether the outcome from the portable storage device is a winning outcome in response to determining that the player identification information input by the player matches the player identification information stored in the corresponding outcome record in the finite pool.

6. A gaming network for conducting an electronic wagering game according to claim 1, wherein each sales terminal comprises an output device operatively coupled to the sales terminal controller,
the sales terminal controller being programmed to encrypt the selected outcomes prior to causing the second input device to store the selected outcomes on the portable storage device,
the sales terminal controller being programmed to cause the output device to provide the player with a decryption key,
the redemption terminal controller being programmed to allow the first redemption input device to receive input of the decryption key by the player, and
the redemption terminal controller being programmed to decrypt the outcomes read from the portable storage device using the decryption key input by the player.

7. A gaming network for conducting an electronic wagering game according to claim 1, wherein the gaming network provides a plurality of electronic wagering games each having a finite pool of outcome records, the sales terminal controller being programmed to cause the selection by the gaming network of at least one outcome from at least one of the finite pools of outcomes based on the player's selections.

8. A gaming network for conducting an electronic wagering game according to claim 1, wherein the selection device of the gaming network is the sales terminal.

9. A method for conducting an electronic wagering game at a gaming network, comprising:
selecting at least one outcome record from a finite pool of outcome records for the wagering game stored in the gaming network;
storing the selected outcome records on a portable storage device;
distributing the portable storage device to a player;
receiving the portable storage device from the player at a redemption device of the gaming network;
reading at least one outcome record from the portable storage device;
determining an outcome for the wagering game based on the information contained in the outcome record; and
dispensing value to the player in response to determining that at least one of the outcomes from the outcome records is a winning outcome.

10. A method for conducting an electronic wagering game according to claim 9, wherein the storing the outcome records comprises:
receiving the portable storage device from the player at a sales device of the gaming network;
downloading the selected outcome records from the sales device to the portable storage device;
dispensing the portable storage device from the sales device to the player.

11. A method for conducting an electronic wagering game according to claim 10, comprising receiving value from the player at the sales device in exchange for the outcome records downloaded to the portable storage device.

12. A method for conducting an electronic wagering game according to claim 10, wherein the sales device and the redemption device are the same device.

13. A method for conducting an electronic wagering game according to claim 9, comprising:
selecting and storing the outcome records on the portable storage device at a first time; and
receiving value from the player in exchange for the stored outcome records and distributing the portable storage device to the player at a later time.

14. A method for conducting an electronic wagering game according to claim 9, comprising:
receiving game option selection information from the player; and
selecting outcome records from the finite pool of outcome records based on the game option selection information.

15. A method for conducting an electronic wagering game according to claim 9, comprising:
storing portable storage device identification information on the portable storage device;
storing the portable storage device identification information with the outcome record in the finite pool corresponding to an outcome record selected and stored on the portable storage device;
comparing the portable storage device identification information stored on the portable storage device to the portable storage device identification information stored in the corresponding outcome record in the finite pool in response to reading an outcome record from the portable storage device; and
determining the outcome for the wagering game based on the information contained in the outcome record in response to determining that the portable storage device identification information stored on the portable storage device matches the portable storage device identification information stored in the corresponding outcome record in the finite pool.

16. A method for conducting an electronic wagering game according to claim 9, comprising:
receiving player identification information from the player at the time of distributing the portable storage device to the player;
storing the player identification information with the outcome record in the finite pool corresponding to an outcome record selected and stored on the portable storage device;
comparing player identification information input by the player at the redemption device to the player identification information stored in the corresponding outcome record in the finite pool in response to reading an outcome record from the portable storage device; and
determining the outcome for the wagering game based on the information contained in the outcome record in response to determining that the player identification information input by the player matches the player identification information stored in the corresponding outcome record in the finite pool.

17. A method for conducting an electronic wagering game according to claim 9, comprising:
encrypting the outcome records prior to storing the outcome records on the portable storage device;
providing the player with a decryption key at the time of distributing the portable storage device to the player; and
decrypting the outcome records read from the portable storage device using the decryption key input by the player at the redemption device.

18. A method for conducting an electronic wagering game according to claim 9, wherein the gaming network provides a plurality of electronic wagering games each having a finite pool of outcome records, the method comprising:
receiving game option selection information from the player; and
selecting outcome records from at least one of the finite pools of outcome records based on the game option selection information.

19. A gaming network for conducting an electronic wagering game wherein each player may purchase at least one outcome from a finite pool of outcomes for the wagering game, the gaming network comprising:
an outcome selection terminal operatively connected to the gaming network, the outcome selection terminal being configured to receive a portable storage device, and to read information from and to write information to a portable storage device received at the outcome selection terminal, and wherein the outcome selection terminal is configured to store outcome records selected from the finite pool of outcome records for the wagering game on a portable storage device received at the outcome selection terminal; and
an outcome redemption terminal operatively connected to the gaming network, the outcome redemption terminal being configured to receive a portable storage device, and to read information from and to write information to a portable storage device received at the outcome redemption terminal, and wherein the outcome selection terminal is configured to read outcome records selected from the finite pool of outcome records for the wagering game stored on a portable storage device received at the outcome selection terminal, to determine outcomes for the wagering game based on the information contained in the outcome records read from a portable storage device, and to dispense value to a player in response to determining that at least one of the outcome records is a winning outcome.

20. A gaming network for conducting an electronic wagering game according to claim 19, wherein the outcome selection terminal is configured to receive value from the player at the sales device, and to store the outcome records in response to receiving value from the player.

21. A gaming network for conducting an electronic wagering game according to claim 19, wherein the outcome selection terminal and the outcome redemption terminal are the same device.

22. A gaming network for conducting an electronic wagering game according to claim 19, wherein the outcome selection terminal is configured to receive game option selection information input by the player, and wherein the outcome records are selected by a device of the gaming network based on the game option selection information.

23. A gaming network for conducting an electronic wagering game according to claim 22, wherein the device of the gaming network selection the outcome records is the outcome selection terminal.

24. A gaming network for conducting an electronic wagering game according to claim 19, wherein portable storage device identification information is stored on the portable storage device,
wherein the outcome selection terminal is configured to cause a device of the gaming network to store the portable storage device identification information with the outcome record in the finite pool corresponding to an outcome record selected and stored on the portable storage device,
wherein the outcome redemption terminal is configured to cause the device of the gaming network to compare the portable storage device identification information stored on the portable storage device to the portable storage device identification information stored in the corresponding outcome record in the finite pool in response to reading an outcome record from the portable storage device, and
wherein the outcome redemption terminal is configured to determine the outcome for the wagering game based on the information contained in the outcome record in response a determination that the portable storage device identification information stored on the portable storage device matches the portable storage device identification information stored in the corresponding outcome record in the finite pool.

25. A gaming network for conducting an electronic wagering game according to claim 19, wherein the outcome selection terminal is configured to receive player identification information input by the player,
wherein the outcome selection terminal is configured to cause a device of the gaming network to store the player identification information with the outcome record in the finite pool corresponding to an outcome record selected and stored on the portable storage device,
wherein the outcome redemption terminal is configured to receive player identification information input by the player,
wherein the outcome redemption terminal is configured to cause the device of the gaming network to compare the player identification information input by the player at the outcome redemption terminal to the player identification information stored in the corresponding outcome record in the finite pool in response to reading an outcome record from the portable storage device, and
wherein the outcome redemption terminal is configured to determine the outcome for the wagering game based on the information contained in the outcome record in response a determination that the player identification information input by the player matches the player identification information stored in the corresponding outcome record in the finite pool.

26. A gaming network for conducting an electronic wagering game according to claim 19, wherein the outcome selection terminal is configured to encrypt the outcome records prior to storing the outcome records on the portable storage device,
wherein the outcome selection terminal is configured to output a decryption key to the player when the encrypted outcome records are stored on the portable storage device,
wherein the outcome redemption terminal is configured to allow the player to input the decryption key, and
wherein the outcome redemption terminal is configured to decrypt the encrypted outcome records read from the portable storage device using the decryption key input by the player at the outcome redemption terminal.

27. A gaming network for conducting an electronic wagering game according to claim 19, wherein the gaming network provides a plurality of electronic wagering games each having a finite pool of outcome records,
wherein the outcome selection terminal is configured to receive game option selection information input by the player, and
wherein the outcome records are selected from at least one of the finite pools of outcome records based on the game option selection information.

28. A gaming network for conducting an electronic wagering game according to claim 19, wherein the outcome selection terminal is configured to dispense the portable storage device to the player after storing the outcome records on the portable storage device.
